(19) United States
(12) Patent Application Publication
(10) Pub. No.: US 2024/0364836 A1
(43) Pub. Date: Oct. 31, 2024

(54) PROFILE EDITING APPARATUS, METHOD FOR CONTROLLING PROFILE EDITING APPARATUS, AND STORAGE MEDIUM

(71) Applicant: CANON KABUSHIKI KAISHA, Tokyo (JP)

(72) Inventor: MICHIHIKO YAMADA, Ibaraki (JP)

(21) Appl. No.: 18/648,123

(22) Filed: Apr. 26, 2024

(30) Foreign Application Priority Data
Apr. 28, 2023 (JP) 2023-074434

(51) Int. Cl. H04N 1/60

(52) U.S. Cl. CPC H04N 1/6019

(57) ABSTRACT

Some embodiments enable adding specific color information to a color profile. Some embodiments of a method for controlling a profile editing apparatus include acquiring a color profile including a table for calculating an output color for an input color, acquiring specific color information in which a relationship between input and output colors different from the output color calculated using the table included in the color profile is uniquely determined, and adding the specific color information to the color profile.

### BACKGROUND

### Field of the Disclosure

The present disclosure relates to a profile editing apparatus, a method for controlling the profile editing apparatus, and a storage medium.

### Description of the Related Art

Japanese Patent Application Laid-Open No. 2001-45310 discusses a technique for storing a plurality of color profiles and selecting and using them according to application. The color profiles include a table for acquiring an output color by calculation.

Japanese Patent Application Laid-Open No. 2005-252728 discusses a technique for storing a specific color list for uniquely determining an output color with respect to a specific input color and, in a case where a specific color is included, converting color information about the specific color into an output color registered in the specific color list. The conversion using the specific color list only replaces a matching input color with an output color, and does not perform calculation.

According to Japanese Patent Applications Laid-Open No. 2001-45310 and No. 2005-252728, it is not possible to store a specific color list separate from a table for acquiring an output color by calculation for each color profile. Accordingly, a user needs to edit or reselect the specific color list separately from selecting a color profile according to printing application and may make a mistake in selection.

### SUMMARY

According to an aspect of the present disclosure, a profile editing apparatus comprises one or more memories that causes, by executing the instructions, the profile editing apparatus to acquire a color profile including a table for calculating an output color for an input color, acquire specific color information in which a relationship between input and output colors different from the output color calculated using the table included in the color profile is uniquely determined, and add the specific color information to the color profile.

Further features of various embodiments will become apparent from the following description of exemplary embodiments with reference to the attached drawings.

### BRIEF DESCRIPTION OF THE DRAWINGS

FIG. 1 is a block diagram illustrating a configuration example of an image forming apparatus.

FIG. 2 illustrates a configuration example of an image processing apparatus.

FIG. 3 illustrates a configuration example of a profile editing apparatus.

FIG. 4 illustrates a configuration example of a profile analysis apparatus.

FIGS. 5A to 5H illustrate charts for selecting an output color.

FIG. 6 is a flowchart illustrating processing for outputting a chart for selecting an output color.

FIG. 7 is a flowchart illustrating processing for embedding a registered color list.

FIG. 8 illustrates a registered color list.

FIG. 9 illustrates a color profile with an embedded registered color list.

FIG. 10 illustrates a user interface (UI) for selecting a color profile.

FIG. 11 illustrates a UI for displaying a color profile.

FIG. 12 illustrates a UI for inputting chart information.

FIG. 13 illustrates a UI notifying a user that a registered color list is embedded.

FIG. 14 illustrates a UI for selecting a color profile.

### DESCRIPTION OF THE EMBODIMENTS

Exemplary embodiments according to the present disclosure will be described with reference to the attached drawings. It is noted that the following exemplary embodiments are not meant to limit the scope of every embodiment, and not all combinations of features described in the exemplary embodiments are essential to every embodiment. The same configurations are described using the same reference numerals.

In recent years, performances of image forming apparatuses have improved, and accordingly, apparatuses that achieve image quality equivalent to that of commercial printing machines have appeared. Thus, each retail store now can more easily print a point of purchase advertising (POP) or the like used in the store. The POP is an advertisement for a sales promotion. At this time, due to differences in printing apparatuses, a POP may be printed in a different color from a color sample. According to the present exemplary embodiment, adjustment is performed in such a case so that printing is performed in the same color as the color sample.

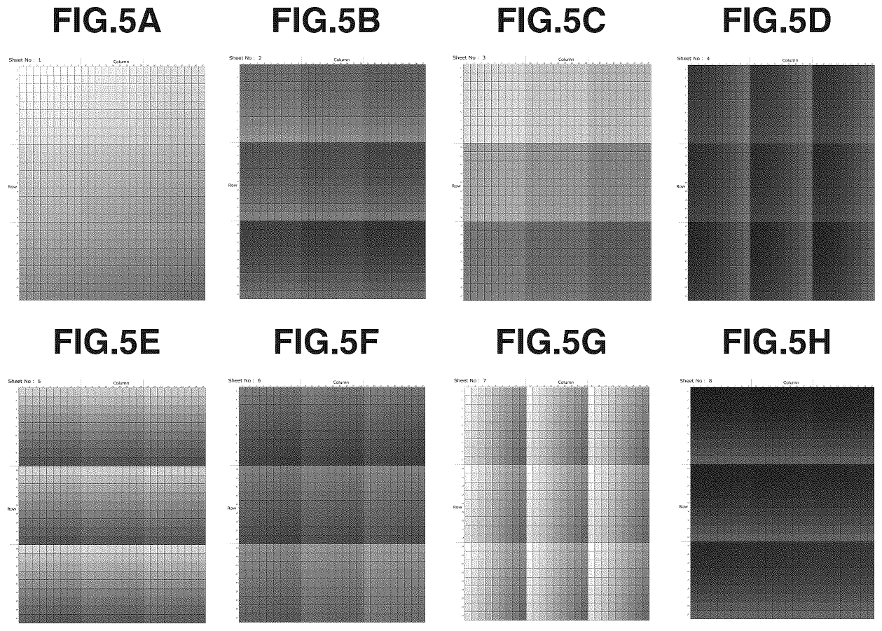

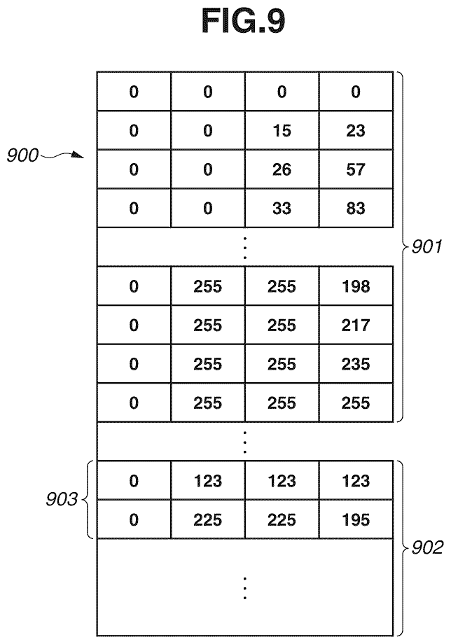

As a simple method for determining a color to be a goal (goal color) of an adjustment target color, there is a method for printing a plurality of goal color candidates calculated from the adjustment target color side by side and prompting a user select the goal color from among the candidates. As a simple method for managing combinations of the adjustment target color and the goal color, there is a method for generating a list of combinations of the adjustment target color and the goal color. However, in a case where the list of combinations of the adjustment target color and the goal color is to be switched according to a print target, it is necessary to select the list again along with other color settings, such as a color profile, which leads to a selection error and requires time and effort. According to the present exemplary embodiment, charts in which a plurality of goal color candidates are arranged (FIGS. 5A to 5H) are printed, a user is asked to select the goal color from the charts, and a registered color list 903 (FIG. 9) in which the adjustment target color and the goal color is combined is stored in a color profile 900 (FIG. 9) selected by the user.

Color adjustment processing using a sample described according to the present exemplary embodiment can be widely applied to image forming apparatuses that perform printing, such as copying machines, laser printers, or inkjet printers, or image display apparatuses, such as monitors or projectors. According to the present exemplary embodiment, a multi-function peripheral (MFP) having a scan function, a print function, a copy function, a transmission function, and the like is to be described as an example. Specifically, an example is to be described in which the color adjustment processing according to the present exemplary embodiment is performed in an image processing apparatus installed in an image forming apparatus.

According to the present exemplary embodiment, colors corresponding to each color space stored in image data are represented by alphabetic characters, such as R, G, B or L, a, b. For example, a red component in a red-green-blue (RGB) color space is represented by R. A green component in the RGB color space is represented by G. A blue component in the RGB color space is represented by B. A relative color space based on a color reproduction range of a device, such as a printer engine or a scanner unit, which is to be described below, is expressed as a “device-dependent color space”. On the other hand, an absolute color space defined as a standard specification is expressed as a “device-independent color space”.

Similar to RGB, color materials to be recorded on a recording medium are represented by alphabetic characters C (cyan), M (magenta), Y (yellow), and K (black) for each color.

Image data is two-dimensional data having a plurality of planes of colors. For example, image data in the RGB color space represents layer structure data of three two-dimensional planes for each of R, G, and B. According to the present exemplary embodiment, color adjustment processing for the same color space is performed using table data storing a value of a discrete point in the color space. Color conversion processing for converting a value that represents the same color in color spaces with different definitions, or color adjustment processing for converting a color space after adding arbitrary adjustment processing, is performed. According to the present exemplary embodiment, a discrete point in the above-described color space is defined as a grid point. The grid point means one element of RGB, Lab, or the like that makes up table data representing the color space. A detailed example of the table data is to be described below.

### <Hardware Configuration of Image Forming Apparatus>

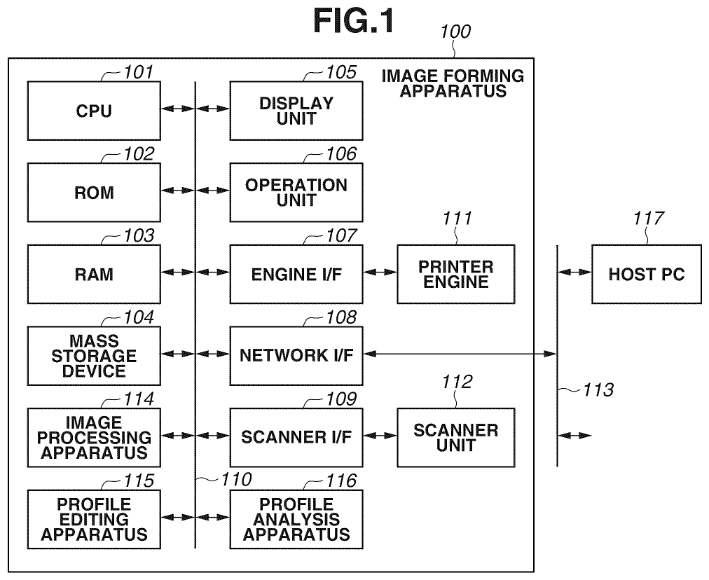

FIG. 1 is a block diagram illustrating an example of a hardware configuration of an image forming apparatus 100 according to the present exemplary embodiment. The image forming apparatus 100 includes a central processing unit (CPU) 101, a read-only memory (ROM) 102, a random access memory (RAM) 103, a mass storage device 104, a display unit 105, an operation unit 106, an engine interface (I/F) 107, a network I/F 108, and a scanner I/F 109. The image forming apparatus 100 includes an image processing apparatus 114, a profile editing apparatus 115, and a profile analysis apparatus 116. Each of these members is mutually connected via a system bus 110.

The image forming apparatus 100 includes a printer engine 111 and a scanner unit 112. The printer engine 111 and the scanner unit 112 are connected to the system bus 110 via the engine I/F 107 and the scanner I/F 109 respectively. The image processing apparatus 114, the profile editing apparatus 115, and the profile analysis apparatus 116 may be configured as apparatuses independent of the image forming apparatus 100.

The CPU 101 controls all the operations of the image forming apparatus 100. The CPU 101 reads a program stored in the ROM 102 into the RAM 103 and executes the program to execute various types of processing to be described below.

The ROM 102 is a read-only memory and stores a system startup program or a program for controlling the printer engine 111, character data or character code information, and the like.

The RAM 103 is a volatile random access memory and is used as a work area for the CPU 101 and a temporary storage area for various data. For example, the RAM 103 is used as a storage area for storing font data additionally registered by downloading, an image file received from an external apparatus, or the like.

The mass storage device 104 is, for example, a hard disk drive (HDD) or a solid state drive (SSD), in which various data are spooled, and is used to store a program, an information file, image data, and the like, and as a work area.

The display unit 105 is configured with, for example, a liquid crystal display (LCD) and is used to display a setting status of the image forming apparatus 100, a status of processing being executed, an error status, and the like. The display unit 105 is used to display candidates for the adjustment target color or the sample color at the time of executing color adjustment processing.

The operation unit 106 is an operation reception unit that includes input devices, such as hard keys and a touch panel provided on the display unit 105, and receives an input (an instruction) by a user operation.

The operation unit 106 is used to change or reset a setting of the image forming apparatus 100. The operation unit 106 is used to execute a color adjustment processing mode of the image forming apparatus 100 in executing color adjustment processing.

The engine I/F 107 functions as an interface for controlling the printer engine 111 in response to an instruction from the CPU 101 in a case where printing is executed. An engine control command or the like is transmitted and received between the CPU 101 and the printer engine 111 via the engine I/F 107.

The network I/F 108 functions as an interface for connecting the image forming apparatus 100 to a network 113. The network 113 may be, for example, a local area network (LAN) or a public switched telephone network (PSTN). A host personal computer (PC) 117 is connected to the network 113.

The printer engine 111 uses developers (toners) of a plurality of colors (here, four colors of CMYK) to form a multicolor image on a recording medium, such as paper, based on print image data received from the system bus 110.

The scanner I/F 109 functions as an interface for controlling the scanner unit 112 in response to an instruction from the CPU 101 in a case where the scanner unit 112 reads a document. A scanner unit control command or the like is transmitted and received between the CPU 101 and the scanner unit 112 via the scanner I/F 109.

The scanner unit 112 reads an image of a document to generate image data under control of the CPU 101, and transmits the image data to the RAM 103 or the mass storage device 104 via the scanner I/F 109.

### <Configuration of Image Processing Apparatus>

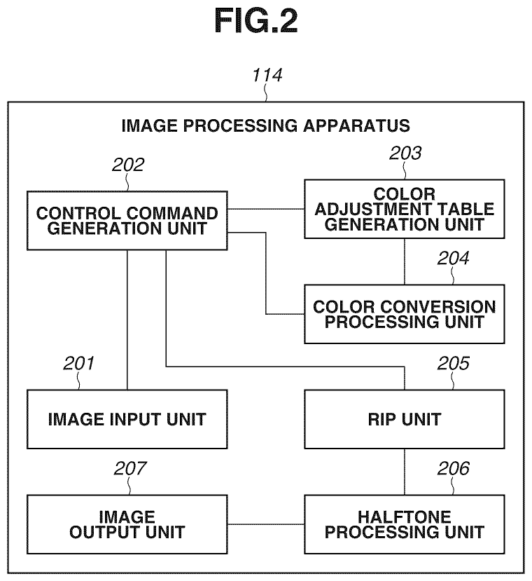

FIG. 2 is a block diagram illustrating an example of a functional configuration of the image processing apparatus 114 in FIG. 1. The image processing apparatus 114 includes an image input unit 201, a control command generation unit 202, a color adjustment table generation unit 203, a color conversion processing unit 204, a raster image processer (RIP) unit 205, a halftone processing unit 206, and an image output unit 207. Each of these functional units is realized by the CPU 101 in FIG. 1 reading a program stored in the ROM 102 into the RAM 103 and executing the program. Also, some or all of these functional units may be realized by hardware such as an application specific integrated circuit (ASIC) or an electronic circuit.

The image input unit 201 receives an input of image data of a print target. The input image data is, for example, image data input from the host PC 117 to the image input unit 201 via the network 113 or the network I/F 108. Also, image data stored in the mass storage device 104 may be input to the image input unit 201. The input image data is, for example, three-layer data that expresses each RGB signal in 8-bit 256 gradations corresponding to a standard RGB (SRGB) color space that is an RGB color space independent of the printer engine 111. According to the present exemplary embodiment, sRGB means the standard specification of the RGB color space defined by the International Electrotechnical Commission (IEC). The image data input to the image input unit 201 is transmitted to the control command generation unit 202.

The control command generation unit 202 controls the color adjustment table generation unit 203 and the color conversion processing unit 204, and generates a control command of the RIP unit 205 based on the input image data (sRGB). A RIP unit control command generated by controlling the color adjustment table generation unit 203 and the color conversion processing unit 204 is transmitted to the RIP unit 205. The RIP unit control command includes image data converted from the sRGB color space to a CMYK color space used by the printer engine 111.

The color adjustment table generation unit 203 generates a color adjustment table for performing arbitrary color adjustment based on an instruction from the operation unit 106. The color adjustment table generation unit 203 generates a color adjustment table for performing color adjustment conversion from the sRGB color space independent of the printer engine 111 to the RGB color space dependent on color reproducibility of the printer engine 111 on image data input to the image input unit 201. Hereinbelow, a device-dependent RGB color space dependent on the color reproducibility of the printer engine 111 is referred to as a devRGB color space. The color adjustment table generation unit 203 includes a predetermined table 901 (FIG. 9) for performing color adjustment conversion from the sRGB color space to the devRGB color space. In a case where color adjustment is performed to bring the adjustment target color closer to a sample color, a second color is adjusted, which is output in a case where the adjustment target color is input to the predetermined table 901 as a first color. Specifically, a color adjustment table (the color profile 900 in FIG. 9) is generated that is adjusted to replace the second color with a third color that is output in a case where the sample color is input to the predetermined table. In other words, in the generated color adjustment table (the color profile 900 in FIG. 9), the above-described third color is output in a case where the adjustment target color is input as the first color. The color adjustment table generation unit 203 according to the present exemplary embodiment performs processing for displaying a suitable adjustment target color candidate in generating color adjustment table data.

The color conversion processing unit 204 performs color conversion processing for converting RGB values (sRGB values) of image data acquired from the control command generation unit 202 into colors in the CMYK color space using the color adjustment table generated by the color adjustment table generation unit 203 and a color conversion table. The color conversion table is stored in the RAM 103 or the mass storage device 104. The color conversion processing unit 204 performs color adjustment conversion from the sRGB color space to the devRGB color space on an input image using the color adjustment table generated by the color adjustment table generation unit 203 to bring the adjustment target color closer to the sample color. Of course, a color other than the adjustment target color is also converted from the sRGB color space to the devRGB color space. The color adjustment is performed in this way, so that the input image is subjected to color adjustment from the RGB color space independent of the printer engine 111 to the devRGB color space, and the adjustment target color is brought closer to the sample color. The color conversion processing unit 204 performs color conversion processing using two color conversion tables: a color conversion table for converting from the devRGB color space to a Lab color space and a color conversion table for converting the color from the Lab color space to the CMYK color space. Accordingly, the color conversion processing unit 204 converts the input image into color values in the CMYK color space. According to the present exemplary embodiment, L*a*b*, which is a three-dimensional visually uniform color space that is independent of the printer engine 111 and takes human visual characteristics into consideration, as defined by the International Commission on Illumination (CIE), is simply referred to as Lab. The color space is converted via a color space that is independent of the printer engine 111, so that reproduction of a color that a person recognizes as the same color is realized. A method for color conversion processing from the devRGB color space to the CMYK color space is not limited to the one that uses the above-described two color conversion tables. For example, the color adjustment table and the two color conversion tables are combined to generate one color conversion table for converting the devRGB color space to the CMYK color space, and this color conversion table may be used to perform color conversion processing.

The RIP unit 205 uses the RIP unit control command (including image data in the CMYK color space) generated by the control command generation unit 202 to generate a CMYK raster image.

The halftone processing unit 206 performs halftone processing on the CMYK raster image generated by the RIP unit 205. Generally, the printer engine 111 often supports output of only a lower number of gradations, such as 2, 4, or 16 gradations, than input image data expressing 256 gradations. Thus, the halftone processing unit 206 performs halftone processing so that stable halftone representation can be output even with a small number of gradations. Various methods can be applied to halftone processing by the halftone processing unit 206, such as a density pattern method, a systematic dither method, or an error diffusion method. The halftone processing unit 206 generates print image data that is image data that can be processed by the printer engine 111 through the above-described processing.

In a case where the print image data is received from the halftone processing unit 206, the image output unit 207 transmits the print image data to the printer engine 111 via the engine I/F 107. The CPU 101 instructs the printer engine 111 to form an image based on the print image data. The printer engine 111 prints a color image according to the input print image data on a recording medium by executing exposure, development, transfer, and fixing processes.

### <Configuration of Profile Editing Apparatus>

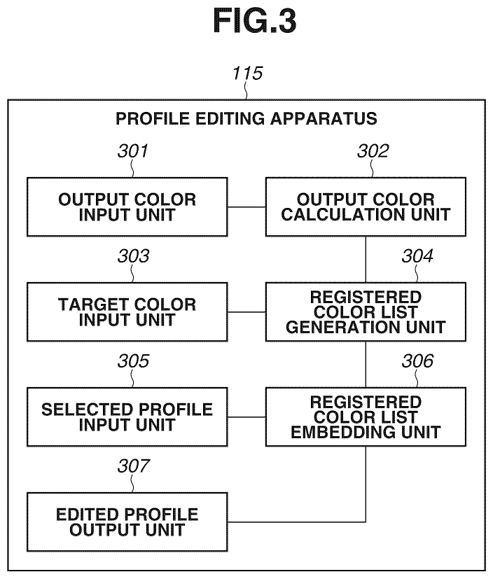

FIG. 3 is a block diagram illustrating an example of a functional configuration of the profile editing apparatus 115 in FIG. 1. The profile editing apparatus 115 includes an output color input unit 301, an output color calculation unit 302, a target color input unit 303, a registered color list generation unit 304, a selected profile input unit 305, a registered color list embedding unit 306, and an edited profile output unit 307. Each of these functional units is realized by the CPU 101 in FIG. 1 reading a program stored in the ROM 102 into the RAM 103 and executing the program. Also, some or all of these functional units may be realized by hardware such as an ASIC or an electronic circuit.

The output color input unit 301 receives a page number, a row number, and a column number of a chart that includes a color selected as an output color of printed charts (FIGS. 5A to 5H), which are input from the operation unit 106, and transmits them to the output color calculation unit 302.

The output color calculation unit 302 calculates RGB values forming the chart from the page number, the row number, and the column number received from the output color input unit 301 and transmits the RGB values as an output color to the registered color list generation unit 304.

The target color input unit 303 receives a target input color input from the operation unit 106 and transmits it to the registered color list generation unit 304.

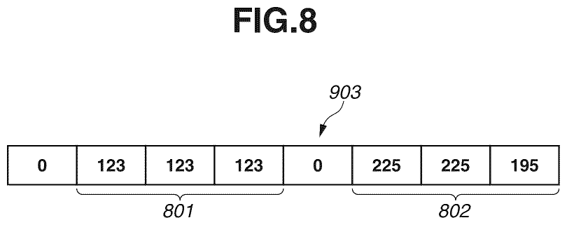

The registered color list generation unit 304 associates a target input color 801 in FIG. 8 received from the target color input unit 303 with an output color 802 in FIG. 8 received from the output color calculation unit 302 to generate the registered color list 903 and transmits it to the registered color list embedding unit 306.

The selected profile input unit 305 acquires the color profile selected by the operation unit 106 from the ROM 102, the RAM 103, or the mass storage device 104 and transmits the acquired color profile to the registered color list embedding unit 306.

The registered color list embedding unit 306 embeds the registered color list 903 generated by the registered color list generation unit 304 in a predetermined position of the color profile in FIG. 9 received from the selected profile input unit 305 and generates an edited color profile 900. The registered color list embedding unit 306 transmits the edited color profile 900 to the edited profile output unit 307.

The edited profile output unit 307 stores the edited color profile 900 received from the registered color list embedding unit 306 in the RAM 103 or the mass storage device 104.

### <Calibration of Profile Analysis Apparatus>

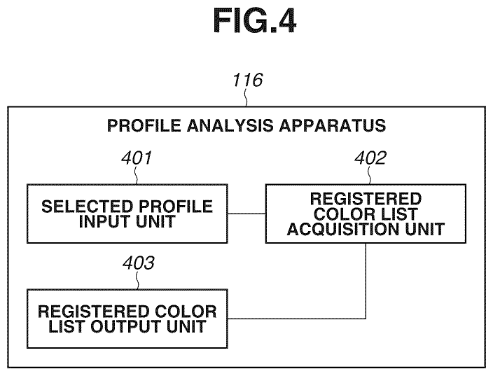

FIG. 4 is a block diagram illustrating an example of a functional configuration of the profile analysis apparatus 116 in FIG. 1. The profile analysis apparatus 116 includes a selected profile input unit 401, a registered color list acquisition unit 402, and a registered color list output unit 403. Each of these functional units is realized by the CPU 101 in FIG. 1 reading a program stored in the ROM 102 into the RAM 103 and executing the program. Also, some or all of these functional units may be realized by hardware such as an ASIC or an electronic circuit.

The selected profile input unit 401 acquires the color profile selected by the operation unit 106 from the ROM 102, the RAM 103, or the mass storage device 104, and transmits the acquired color profile to the registered color list acquisition unit 402.

The registered color list acquisition unit 402 acquires the registered color list 903 from the predetermined position in the color profile 900 in FIG. 9 received from the selected profile input unit 401 and transmits the registered color list 903 to the registered color list output unit 403.

The registered color list output unit 403 stores the registered color list 903 received from the registered color list acquisition unit 402 in the RAM 103.

FIGS. 5A to 5H illustrate output color selection charts for selecting an output color for a specific input color. The color output selection chart is transmitted from the host PC 117 via the network 113, subjected to image processing by the image processing apparatus 114, and output to the printer engine 111. In a case where the color conversion processing unit 204 in the image processing apparatus 114 performs color conversion on the output color selection chart, the color conversion processing unit 204 performs color conversion processing directly from the devRGB color space to the CMYK color space without using the color adjustment table. The output color selection chart is made of, for example, a color sample in which color patches are arranged by changing colors in the devRGB color space. A method for changing a color is determined by, for example, having a table of change amounts for each of R, G, and B, and adding it to the adjustment target color. Assuming that the R, G, and B components of the adjustment target color are respectively Rin, Gin, and Bin, color values of the R, G, and B components after change are respectively Rout, Gout, and Bout, and amount of changes are x, y, and z, they are determined by the following formulae. A change number is indicated by i, and a table of change amounts is used.

$$Rout ( i ) = Rin + x ( i ) + y ( i ) + z ( i ) \\ Gout ( i ) = Gin + x ( i ) + y ( i ) + z ( i ) \\ Bout ( i ) = Bin + x ( i ) + y ( i ) + z ( i )$$

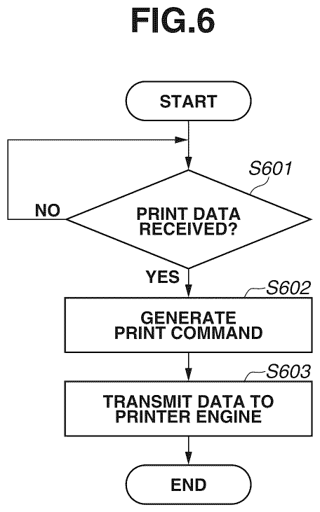

FIG. 6 is a flowchart illustrating processing until the image forming apparatus 100 according to the present exemplary embodiment outputs the output color selection charts (FIGS. 5A to 5H) received from the host PC 117.

Each step is to be described with reference to FIG. 1 to FIGS. 5A to 5H. The processing in each step in the flowchart in FIG. 6 is realized in the image forming apparatus 100 by the CPU 101 in FIG. 1 reading a program stored in the ROM 102 into the RAM 103 and executing the program.

In step S601, the CPU 101 determines whether print data of the output color selection charts (FIGS. 5A to 5H) is received from the host PC 117. In a case where the output color selection charts (FIGS. 5A to 5H) are not received (NO in step S601), the CPU 101 repeats the processing in step S601. In a case where the output color selection charts (FIGS. 5A to 5H) are received (YES in step S601), the CPU 101 transmits the output color selection charts (FIGS. 5A to 5H) to the image processing apparatus 114 and advances the processing to step S602.

In step S602, the image input unit 201 in the image processing apparatus 114 inputs the print data of the output color selection charts (FIGS. 5A to 5H) and transmits a print command of the output color selection charts (FIGS. 5A to 5H) to the control command generation unit 202. The control command generation unit 202 generates a RIP unit control command based on the output color selection charts (FIGS. 5A to 5H). The output color selection charts (FIGS. 5A to 5H) are expressed in the devRGB color space, so that the color adjustment table generation unit 203 does not generate the color adjustment table. The color conversion processing unit 204 performs conversion from the devRGB color space to the CMYK color space without using the color adjustment table. The RIP unit 205 generates a CMYK raster image using the RIP unit control command. The halftone processing unit 206 performs halftone processing on the CMYK raster image to generate print image data and transmits it to the image output unit 207.

In step S603, the image output unit 207 transmits the print image data to the printer engine 111 via the engine I/F 107. The printer engine 111 prints a color image on a recording medium according to the print image data. Accordingly, the processing in the flowchart in FIG. 6 is completed.

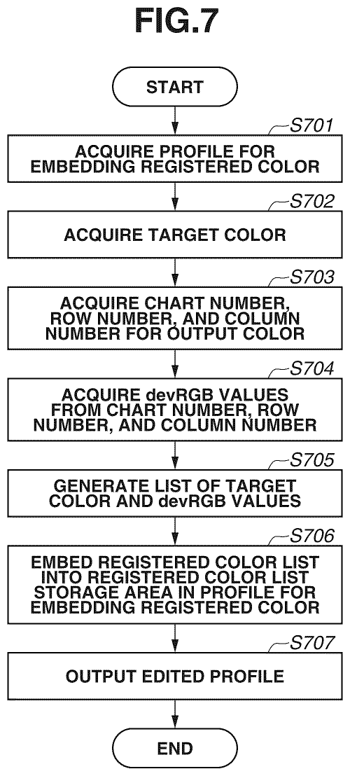

FIG. 7 is a flowchart illustrating processing until the image forming apparatus 100 according to the present exemplary embodiment embeds a registered color list in which a relationship between input and output is uniquely determined into a predetermined color profile. The processing in each step in the flowchart in FIG. 7 is realized in the image forming apparatus 100 by the CPU 101 in FIG. 1 reading a program stored in the ROM 102 into the RAM 103 and executing the program. A processing method of the profile editing apparatus 115 is to be described below.

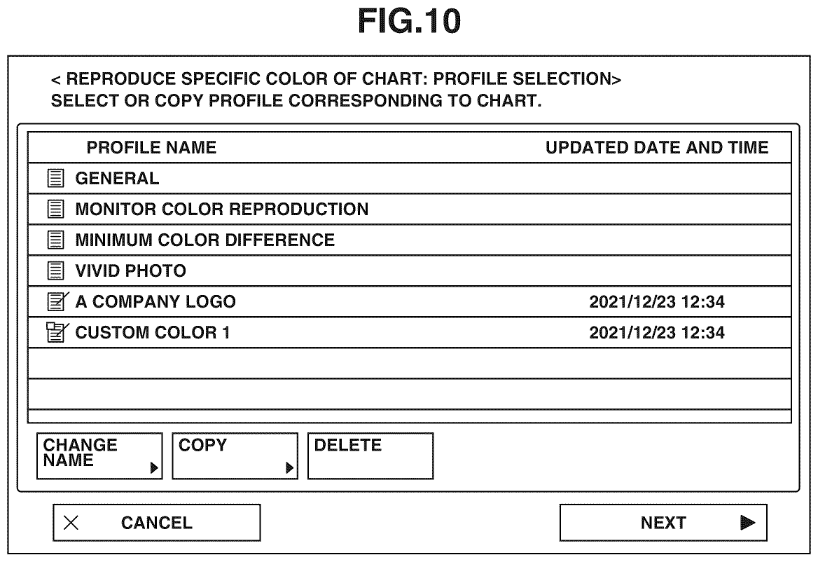

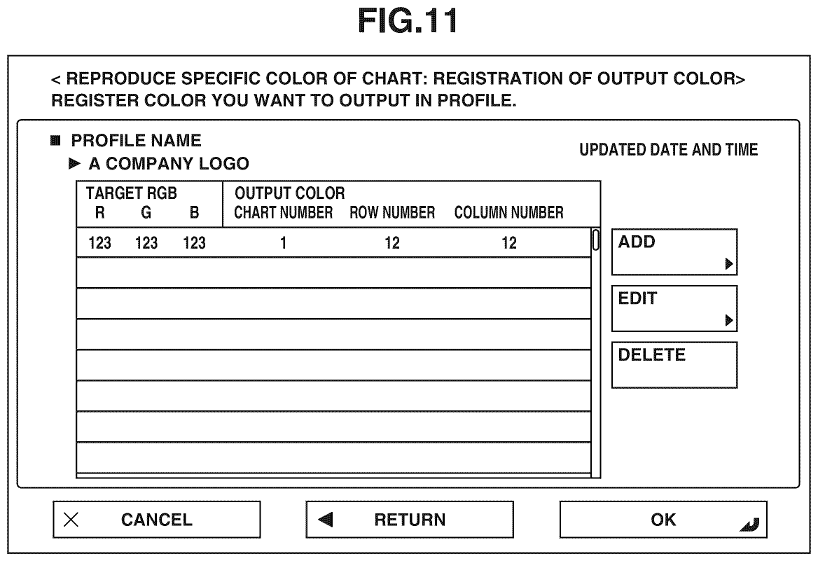

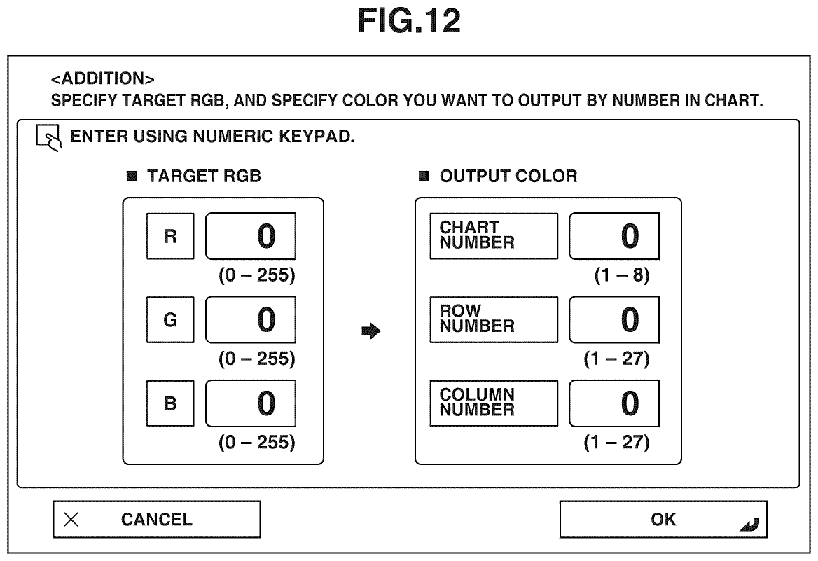

In step S701, the CPU 101 functions as an acquisition unit and acquires the color profile selected on a profile selection screen for embedding a registered color in FIG. 10 displayed on the display unit 105. The CPU 101 transmits the acquired color profile to the selected profile input unit 305 in the profile editing apparatus 115. The selected profile input unit 305 inputs, for example, the table 901 of the color profile 900 in FIG. 9. The table 901 is a predetermined color profile that has a mapping of the input color and the output color in the color space in a table format and is used to acquire the output color for the input color by calculation, such as interpolation. The table 901 is not limited to a unique format table, and may be an International Color Consortium (ICC) profile, for example. In a case where the color profile is selected on the profile selection screen for embedding registered color in FIG. 10, the CPU 101 displays information of the selected color profile in a screen in FIG. 11 on the display unit 105. In a case where an “ADD” button on the screen in FIG. 11 is pressed, the CPU 101 displays a registered color information input screen in FIG. 12 on the display unit 105. Subsequently, the processing proceeds to step S702.

In step S702, the CPU 101 acquires the target color (RGB) input on the registered color information input screen in FIG. 12 displayed on the display unit 105, and transmits the acquired target color to the target color input unit 303 in the profile editing apparatus 115. Subsequently, the processing proceeds to step S703.

In step S703, the CPU 101 acquires a chart number, a row number, and a column number of the output color input with reference to the output color selection charts (FIGS. 5A to 5H) on the registered color information input screen in FIG. 12 displayed on the display unit 105. The chart number, the row number, and the column number are chart information. The CPU 101 transmits the acquired chart number, row number, and column number to the output color input unit 301 in the profile editing apparatus 115. Subsequently, the processing proceeds to step S704.

In step S704, the output color calculation unit 302 in the profile editing apparatus 115 calculates devRGB values forming the chart from the chart number, the row number, and the column number of the output color input to the output color input unit 301 and transmits the devRGB values to the registered color list generation unit 304. Subsequently, the processing proceeds to step S705.

In step S705, the registered color list generation unit 304 in the profile editing apparatus 115 combines the target input color 801 in FIG. 8 input to the target color input unit 303 and devRGB values 802 in FIG. 8 input from the output color calculation unit 302 to generate the registered color list 903 in FIG. 8. For example, the target input color 801 includes the RGB values of the input color, and the devRGB values 802 are the RGB values of the output color. The registered color list generation unit 304 may acquire the registered color list 903 in response to an input on the registered color information input screen in FIG. 12. The registered color list 903 includes information about the target input color 801 and information about the devRGB values 802. The registered color list generation unit 304 transmits the generated registered color list 903 in FIG. 8 to the registered color list embedding unit 306. The processing proceeds to step S706.

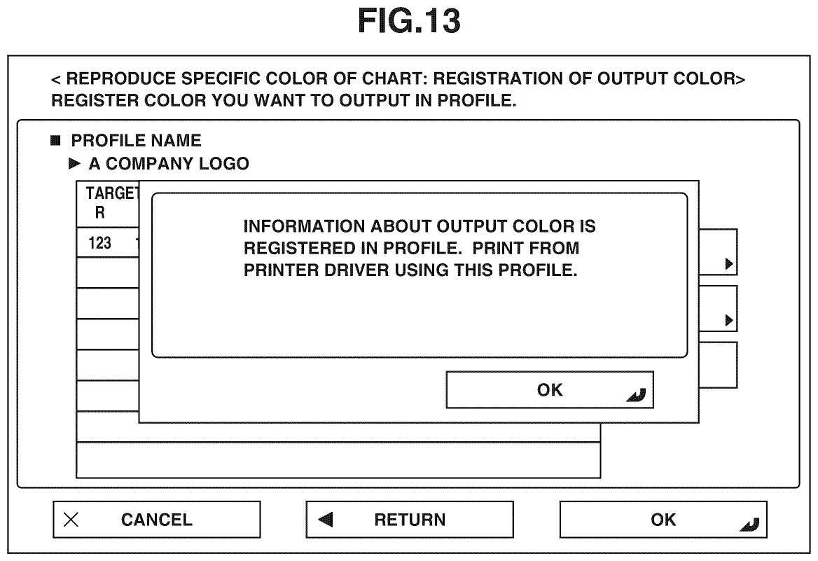

In step S706, the registered color list embedding unit 306 embeds the registered color list 903 in FIG. 8 input from the registered color list generation unit 304 in a registered color list storage area 902 of the color profile 900 in FIG. 9 input to the selected profile input unit 305. The registered color list storage area 902 is an area immediately after the table 901 of the color profile 900 in FIG. 9 input to the selected profile input unit 305. The registered color list 903 in FIG. 8 is embedded in the registered color list storage area 902 of the color profile 900 in FIG. 9. The table 901 is a table for calculating an output color and is the predetermined color profile. The registered color list 903 is specific color information in which a relationship between the target input color 801 and the output color 802 in FIG. 8 is uniquely determined and is information about input and output colors different from the output color calculated using the table 901. The registered color list embedding unit 306 displays a registration completion message in FIG. 13 on the display unit 105, and transmits the color profile 900 in FIG. 9 in which the registered color list 903 is embedded to the edited profile output unit 307. Subsequently, the processing proceeds to step S707.

In step S707, the edited profile output unit 307 functions as a registration unit, and registers the color profile 900 in FIG. 9 by storing the color profile 900 in FIG. 9 in the RAM 103 or the mass storage device 104 of the image forming apparatus 100. Accordingly, the processing in the flowchart in FIG. 7 is completed.

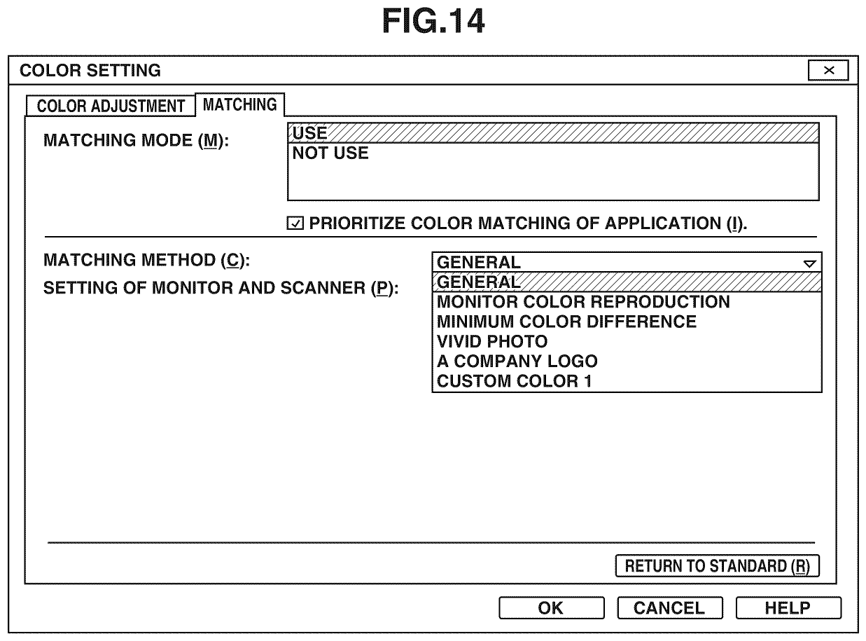

As described above, according to the present exemplary embodiment, the profile editing apparatus 115 adds and embeds the registered color list 903 in which a relationship between input and output colors is uniquely determined in the table 901 of the color profile 900 in FIG. 9 for performing color matching. The host PC 117 selects the color profile 900 as illustrated in a screen in FIG. 14, for example, by a user operation, and transmits the print data to the image forming apparatus 100. The image processing apparatus 114 can perform conversion to a color determined in the registered color list 903 on the print data according to the selected color profile 900 and perform printing. Accordingly, a user no longer needs to generate or reselect the registered color list 903 other than selecting the color profile 900 using the host PC 117, and can reduce a selection error and selection time and effort.

The image input unit 201 in the image processing apparatus 114 receives selection of the color profile and an input of image data of a print target from the host PC 117. The color conversion processing unit 204 performs color adjustment conversion from the sRGB color space to the devRGB color space on the input image data based on the table 901 and the registered color list 903 in the selected color profile 900 in FIG. 9 to bring the adjustment target color closer to the sample color. The color conversion processing unit 204 performs color conversion processing using two color conversion tables: the color conversion table for converting from the devRGB color space to the Lab color space and the color conversion table for converting the color from the Lab color space to the CMYK color space. Accordingly, the color conversion processing unit 204 converts the input image data into image data in the CMYK color space. The RIP unit 205 generates a CMYK raster image based on the image data in the CMYK color space. The halftone processing unit 206 performs halftone processing on the CMYK raster image generated by the RIP unit 205 to generate print image data. Upon receiving the print image data from the halftone processing unit 206, the image output unit 207 transmits the print image data to the printer engine 111 via the engine I/F 107. The printer engine 111 print a color image according to the input print image data on a recording medium.

According to the present exemplary embodiment, the image processing apparatus 114 performs color adjustment based on the color profile 900 in which the registered color list 903 is embedded and thus can perform printing in appropriate colors. A user can select the registered color list 903 by simply selecting the color profile 900 according to application using the host PC 117 and can reduce a selection error and selection time and effort in the registered color list 903.

According to the present exemplary embodiment, the example is described in which the table 901 and the registered color list 903 in FIG. 9 are expressed in the RGB color space, but some embodiments are not limited to this example. The table 901 and the registered color list 903 in FIG. 9 are expressed, for example, in a color space with three or more channels. The color space with three or more channels is, for example, the RGB color space or the CMYK color space.

According to the present exemplary embodiment, the example is described in which the registered color list 903 is registered in the table 901 in a unique format, but some embodiments are not limited to this example. The table 901 may be an ICC profile. In this case, in step S706, the registered color list embedding unit 306 registers the registered color list 903 in a private tag of the ICC profile. As described above, the registered color list embedding unit 306 may register the registered color list 903 in association with the table 901.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-074434. which was filed on April 28. 2023 and which is hereby incorporated by reference herein in its entirety.

What is claimed is:

1. A profile editing apparatus comprising:
one or more memories that stores instructions; and
one or more processors that causes, by executing the instructions, the profile editing apparatus to:
acquire a color profile including a table for calculating an output color for an input color;
acquire specific color information in which a relationship between input and output colors different from the output color calculated using the table included in the color profile is uniquely determined; and
add the specific color information to the color profile.

2. The profile editing apparatus according to claim 1, wherein the color profile and the specific color information are expressed in a color space with three or more channels.

3. The profile editing apparatus according to claim 2, wherein the color space with three or more channels is a red-green-blue (RGB) color space.

4. The profile editing apparatus according to claim 2, wherein the color space with three or more channels is a cyan-magenta-yellow-black (CMYK) color space.

5. The profile editing apparatus according to claim 1, wherein the color profile is an International Color Consortium (ICC) profile.

6. The profile editing apparatus according to claim 5, wherein the specific color information is added as a private tag of the ICC profile.

7. The profile editing apparatus according to claim 1, wherein the specific color information includes information about an input color and information about an output color.

8. The profile editing apparatus according to claim 1, wherein the one or more processors further causes, by executing the instructions, the profile editing apparatus to acquire a value of an input color and a value of an output color based on chart information as the specific color information.

9. An image forming apparatus comprising:
the profile editing apparatus according to claim 1; and
an image processing apparatus configured to perform color adjustment on image data based on the color profile and the specific color information and to generate print image data.

10. A method for controlling a profile editing apparatus, the method comprising:
acquiring a color profile including a table for calculating an output color for an input color;
acquiring specific color information in which a relationship between input and output colors different from the output color calculated using the table included in the color profile is uniquely determined; and
adding the specific color information to the color profile.

11. A computer readable storage medium storing computer-executable instructions for causing a computer to execute a method for controlling a profile editing apparatus, the method comprising:
acquiring a color profile including a table for calculating an output color for an input color;
acquiring specific color information in which a relationship between input and output colors different from the output color calculated using the table included in the color profile is uniquely determined; and
adding the specific color information to the color profile.
